(19) United States
(12) Patent Application Publication
(10) Pub. No.: US 2016/0041251 A1
(43) Pub. Date: Feb. 11, 2016

(54) ULTRASOUND-BASED LOCATION DETERMINATION AND INERTIAL NAVIGATION WITH ACCURACY IMPROVEMENT IN DETERMINING CLIENT DEVICE LOCATION

(71) Applicant: Corning Optical Communications LLC, Hickory, NC (US)

(72) Inventor: Ulrich Wilhelm Heinz Neukirch, Painted Post, NY (US)

(21) Appl. No.: 14/919,831

(22) Filed: Oct. 22, 2015

Related U.S. Application Data
(63) Continuation of application No. PCT/US2014/033452, filed on Apr. 9, 2014.
(60) Provisional application No. 61/815,900, filed on Apr. 25, 2013.

(51) Int. Cl. G01S 3/80

(52) U.S. Cl. CPC G01S 3/80

(57) ABSTRACT

Spatially located ultrasound beacons are provided in known locations within a distributed communication system. The ultrasound beacons are configured to emit ultrasound pulses that can be received by client devices in ultrasound communication range of the beacons. The client devices analyze the received ultrasound pulses from the beacons to determine their time-difference of arrival and as a result, their location(s) within the distributed communication system. The client devices have inertial navigation systems (NS) that calculate client device location as the client device moves, and when received ultrasound signals are below a predefined threshold. Suspected errors in the location information from either the ultrasound or INS systems may be compared against the other system, or compared against reference information, to determine the validity of the location information.

### RELATED APPLICATION

This application is a continuation of International Application No. PCT/US14/33452 filed on Apr. 9, 2014, which claims the benefit of priority to U.S. Provisional Application No. 61/815,900, filed on Apr. 25, 2013, both applications being incorporated herein by reference.

### BACKGROUND

1. Field of the Disclosure

The technology of the disclosure relates to distributed communication systems, and in particular devices, systems, and methods to determine the location of client devices.

2. Technical Background

Wireless communications are subject to increasing demands for high-speed mobile data communications. “Wireless fidelity” or “WiFi” systems and wireless local area networks (WLANs) are now deployed in many different types of areas to provide wireless services. Distributed antenna systems also provide a variety of wireless services by communicating with wireless devices called “client devices” which must reside within the wireless range or “cell coverage area.” Distributed antenna systems are particularly useful inside buildings or other indoor environments where client devices may not otherwise receive radio frequency (RF) signals. Distributed antenna systems have RF antenna coverage areas, also referred to as “antenna coverage areas,” having a relatively short range—from a few meters up to twenty meters.

FIG. 1 is a schematic diagram of an optical fiber-based distributed antenna system 10. The system 10 generates antenna coverage areas for establishing communication with wireless client devices located within the RF range of the antenna coverage areas. The system 10 includes a central unit or head-end unit (HEU) 12, remote antenna units (RAUs) 14, and an optical fiber link 16 that couples the HEU 12 to the RAU 14. The HEU 12 receives communications over downlink electrical RF signals 18D from a source or sources and provides the communications to the RAU 14. The downlink communication signals are received through a downlink input. The HEU 12 is also configured to return communications received from the RAU 14, via uplink electrical RF signals 18U, back to the sources. The optical fiber link 16 includes downlink optical fibers 16D to carry signals communicated from the HEU 12 to the RAU 14 and uplink optical fibers 16U to carry signals communicated from the RAU 14 back to the HEU 12. An interface couples the HEU 12 to the optical fiber link 16 by receiving downlink communication signals and passing them to the RAU 14 through the link 16.

The system 10 has an antenna coverage area 20 that can be substantially centered about the RAU 14. The antenna coverage area 20 of the RAU 14 forms an RF coverage area 22. The HEU 12 performs a number of Radio-over Fiber (RoF) applications, such as radio-frequency identification (RFID), WLAN communication, and cellular phone service. Shown within the antenna coverage area 20 is a client device 24 in the form of a mobile terminal, which may be a cellular telephone, smart phone, or a tablet computer. The client device 24 includes an antenna 26 adapted to receive and/or send RF signals. The HEU 12 includes an electrical-to-optical (E/O) converter 28 to communicate the electrical RF signals over the downlink optical fiber 16D to the RAU 14, to in turn be communicated to the client device 24 in the antenna coverage area 20 formed by the RAU 14. The E/O converter 28 converts the downlink electrical RF signals 18D to downlink optical RF signals 30D to be communicated over the downlink optical fiber 16D. The RAU 14 includes an optical-to-electrical (0/E) converter 32 to convert received downlink optical RF signals 30D back to electrical signals to be communicated wirelessly through an antenna 34 of the RAU 14 to client devices 24 located in the antenna coverage area 20.

The antenna 34 receives wireless RF communications from client devices 24 and communicates electrical RF signals representing the wireless RF communication to an E/O converter 36 in the RAU 14. The E/O converter 36 converts the electrical RF signals into uplink optical RF signals 30U to be communicated over the uplink optical fiber 16U. An 0/E converter 38 in the HEU 12 converts the uplink optical RF signals 30U into uplink electrical RF signals, which are then communicated as uplink electrical RF signals 18U back to a network.

One desirable wireless service is the ability to inform the owner of a client device of their location, sometimes referred to as “localization.” Outside networks such as global positioning services (GPS) provide localization services, but are often ineffective in providing such services indoors where GPS signals are usually too weak. Conventional indoor wireless systems have been proposed to provide localization, but conventional systems typically have insufficient resolution (e.g., ten meters) due to the spacing of the system's wireless access points. Thus, conventional systems would require additional wireless data devices for client device localization at lower resolution distances (e.g., less than ten meters), which increases the cost and complexity of the system.

### SUMMARY OF THE DETAILED DESCRIPTION

One embodiment of the disclosure relates to a method of an RF communication client device configured to communicate in a distributed communication system for determining location within the distributed communication system. The method comprises calculating a first position of the client device, calculating a second position of the client device, evaluating the validity of the second position with respect to the first position, and, if the second position is found to be invalid, reevaluating the second position.

According to one aspect, the validity of a second position can be evaluated by determining whether a velocity required to move from the first position to the second position exceeds a reference velocity.

According to another aspect, the validity of a second position determined by ultrasound signals received at the client device can be evaluated by comparing position information from the ultrasound signals with position information from an inertial navigation system (INS) within the client device.

According to another aspect, the validity of a second position determined by an NS in the client device can be evaluated by comparing the INS position information with position information from ultrasound signals received at the client device.

Additional features and advantages will be set forth in the detailed description which follows, and in part will be apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE FIGURES

FIG. 1 is a schematic diagram of an optical fiber-based distributed communication system;

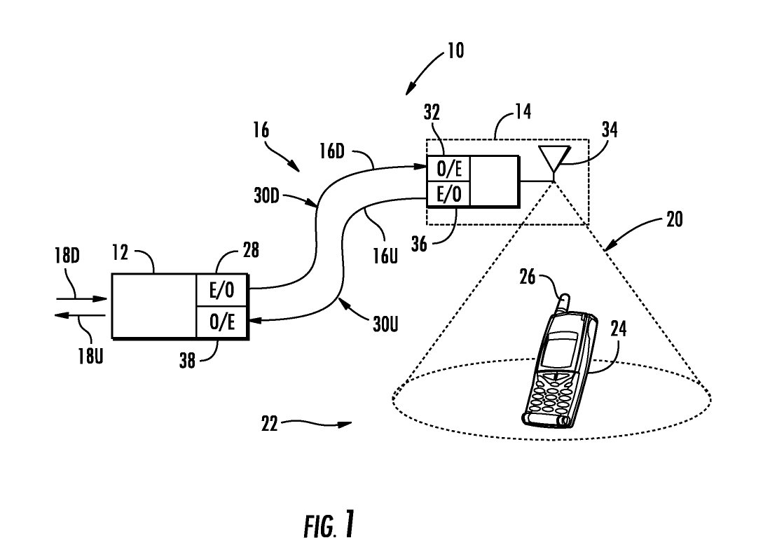

FIG. 2 is a schematic diagram of a distributed communication system employing a plurality of ultrasound beacons organized in clusters configured to emit ultrasound pulses;

FIG. 3 is a schematic diagram of a distributed communication system employing ultrasound beacon clusters in different floors of a building;

FIG. 4 is a flowchart illustrating a process of an ultrasound beacon receiving radio-frequency (RF) signals including synchronization information used by ultrasound beacons to synchronize their internal clocks;

FIG. 5 is a schematic diagram of an ultrasound beacon that can be employed in the distributed communication system in FIG. 2;

FIG. 6 is a flowchart illustrating a process of an ultrasound beacon emitting ultrasound pulses to be received by client devices;

FIGS. 7A and 7B are flowcharts illustrating a process of a client device receiving ultrasound pulses from ultrasound beacons and time-difference-of-arrival to determine device location;

FIG. 8 is a schematic diagram of a client device configured with an ultrasound receiver configured to receive ultrasound pulses and/or location information encoded in ultrasound pulses;

FIG. 9 is a schematic diagram illustrating ultrasound beacons, which may be the exemplary ultrasound beacon in FIG. 4, included in remote units in a distributed communication system, which may be the system in FIG. 2;

FIG. 10 illustrates an ultrasound cluster with only two ultrasound beacons according to an exemplary embodiment;

FIG. 11 is a flowchart illustrating alternate position calculation processes;

FIG. 12 is a schematic diagram of an alternate distributed communication system having a supplementary ultrasound system;

FIG. 13 is a flowchart illustrating an alternate embodiment of position calculation processes for a system using a supplementary ultrasound system; and

FIG. 14 is a flowchart illustrating a method for improving the accuracy of position calculation apparatuses and methods in accordance with the present embodiments.

### DETAILED DESCRIPTION

Ultrasound is sound at one or more wave frequencies higher than is audible to the unaided human ear. The upper frequency limit of human hearing is different for different individuals and generally decreases with increasing age. In general, the lower limit of ultrasound wave frequencies may be approximately 16 KHz or 20 KHz. Ultrasound pulses are bursts of ultrasound waves. According to one aspect of the present embodiments, client devices are configured to analyze received ultrasound pulses from a plurality of ultrasound beacons to determine their time-difference of arrivals at the client device. As a result, the client devices can determine their relative distance to ultrasound beacons in a distributed communication system, and thus determine the location of the client device. Use of ultrasound pulses to determine client device location in a distributed antenna system, or distributed communication system, can provide greater resolution (e.g., sub-meter resolution) than conventional localization methods. Increased resolution results from the lower velocity of sound (as opposed to light or radio-frequency signals), which translates into lessened requirements for time resolution in ultrasound pulse measurements. Ultrasound waves also experience strong attenuation in buildings walls, ceilings, and floors. This allows for a relatively high density beacon deployment in an infrastructure with little chance that a client device will receive ultrasound signals from a beacon not in proximity with the client device, such as a beacon on a different floor. Client devices may comprise inertial navigation systems (INS) that calculate client device location as the client device moves. A client device could rely on INS location, for example, when signals received from ultrasound beacons fall below a signal strength threshold.

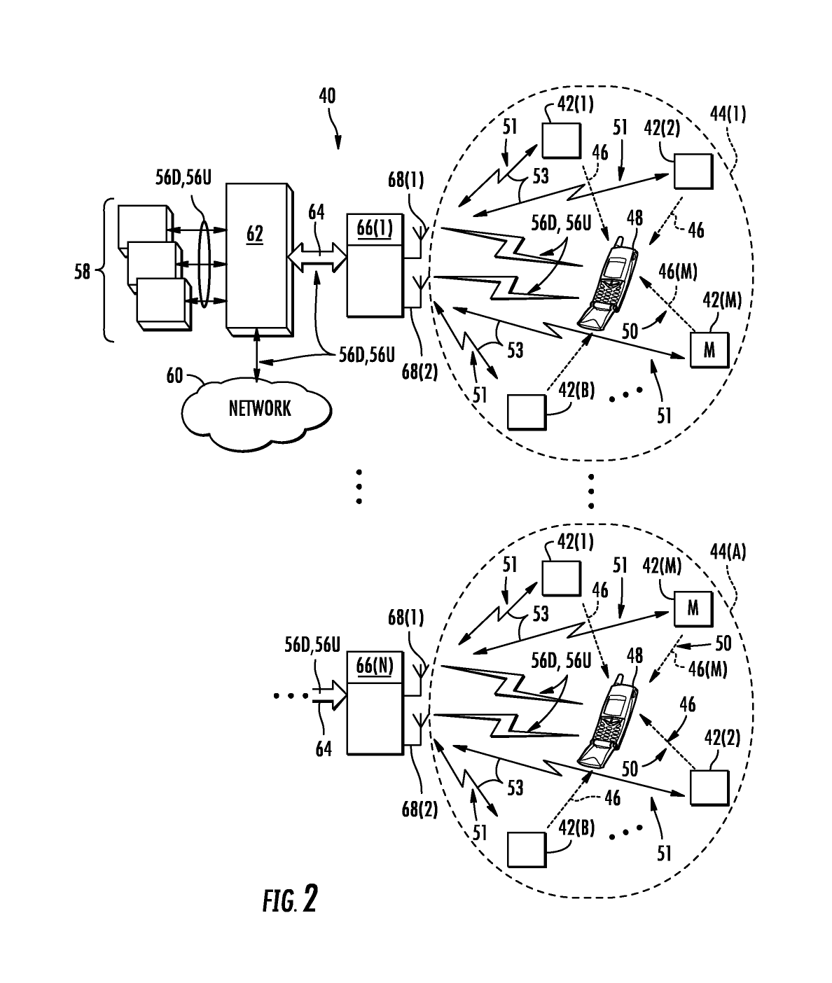

FIG. 2 is a schematic diagram of an exemplary distributed communication system 40 employing a plurality of ultrasound beacons 42 organized in ultrasound beacon clusters 44. The ultrasound beacons 42 are configured to emit ultrasound pulses 46 to be received by client devices 48 in the distributed communication system 40. The system 40 may be deployed indoors in a building or other structure where it is difficult or impossible for the client device 48 to receive global positioning system (GPS) signals. In this example, a plurality of ultrasound beacon clusters 44(1)-44(A) are provided, wherein ‘A’ can be any positive whole integer. Each ultrasound beacon cluster 44(1)-44(A) includes a plurality of non-master ultrasound beacons 42(1)-42(B) and one master ultrasound beacon 42(M) in this example, where ‘B’ can be any positive whole integer.

Each master ultrasound beacon 42(M) encodes its location and the locations of the ultrasound beacons 42(1)-42(B) in its cluster 44 with the ultrasound pulses 46(M) emitted to the client devices 48. This information is shown as location information 50. The client devices 48 are equipped with a microphone that allows them to receive ultrasound pulses 46 from other ultrasound beacons 42(1)-42(B). Client devices 48 are also configured to determine their locations using the received location information 50. In one embodiment, a client device 48 uses time-difference-of-arrival analysis to determine its location relative to the master ultrasound beacon 42(M) and the non-master ultrasound beacons 42(1)-42(B).

With continuing reference to FIG. 2, the ultrasound beacons 42(1)-42(B), 42(M) are also capable of receiving synchronization information 51 over received communication signals or synchronization signals, which are RF synchronization signals 53 in this example. The synchronization signals could be provided by other communication methods or mediums, such as described in U.S. Pat. No. 8,175,649, which is hereby incorporated by reference in its entirety. In this example, the RF synchronization signals 53 are distributed by the remote units 66(1)-66(N) in the distributed communication system 40 to the ultrasound beacons 42(1)-42(B), 42(M). The synchronization information 51 is used by the ultrasound beacons 42(1)-42(B), 42(M) to synchronize their internal clocks used to control emission of the ultrasound pulses 46, 46(M). In this manner, the client devices 48 can distinguish between ultrasound pulses 46, 46(M) received from different ultrasound beacons 42(1)-42(B), 42(M) to facilitate time-difference-of-arrival calculations. By synchronizing the ultrasound beacons 42(1)-42(B), 42(M), the client devices 48 do not have to be synchronized with the ultrasound beacons 42(1)-42(B), 42(M).

Different numbers of ultrasound beacons 42 can be provided in different ultrasound beacon clusters 44(1)-44(A) as long as at least one master ultrasound beacon 42(M) and a plurality of other non-master ultrasound beacons 42(1)-42(B) are provided in each cluster 44(1)-44(A). The ultrasound beacon clusters 44(1)-44(A) may be arranged such that a client device 48 receives ultrasound pulses 46 only from ultrasound beacons 42 in one ultrasound beacon cluster 44(1)-44(A) for a given location of the client device 48. This limitation can be provided as range limitations by placement of the ultrasound beacon clusters 44(1)-44(A) with respect to each other and/or differences in carrier frequencies. In this manner, the client device 48 does not receive ultrasound pulses 46 from two different ultrasound beacon clusters 44(1)-44(A) that cannot be compared in a time-difference-of-arrival analysis at a given location. Also, the client device 48 would not receive location information 50 from multiple master ultrasound beacons 42(M) in a given location of the client device 48.

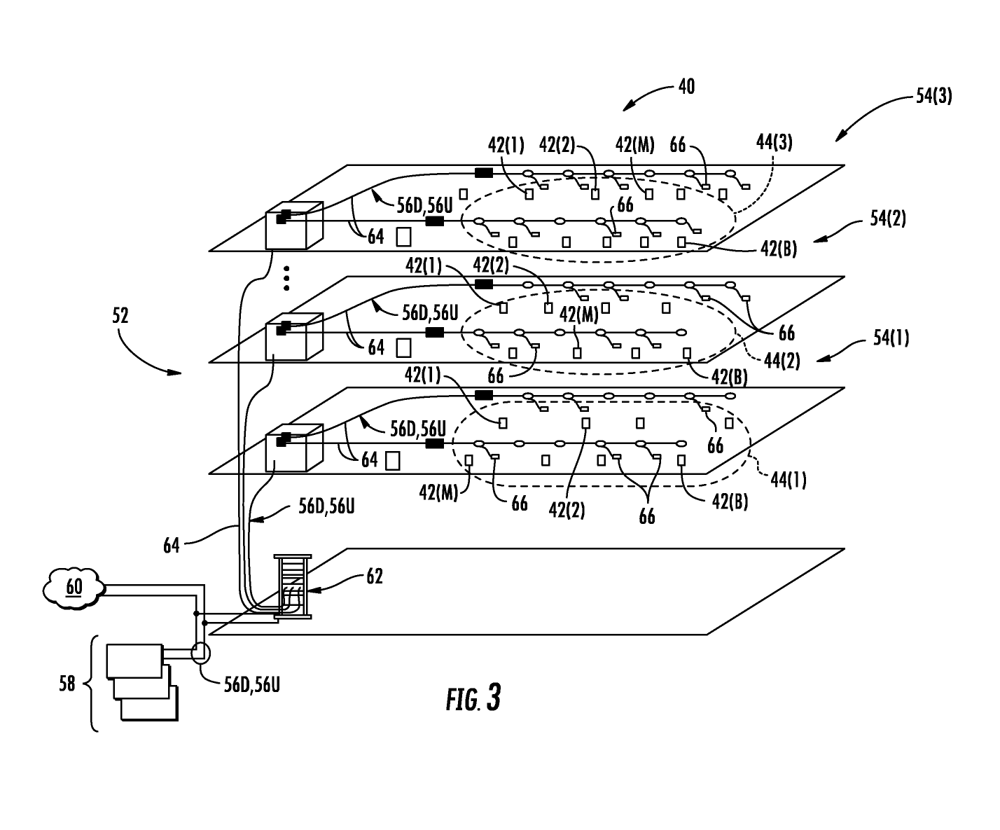

As illustrated in FIG. 3, the distributed communication system 40 may be deployed in a building infrastructure 52, with ultrasound beacon clusters 44(1)-44(A) deployed on each floor. For example, the ultrasound beacon cluster 44(1) may be provided on a first floor 54(1), the cluster 44(2) on a second floor 54(2), and the cluster 44(3) on a third floor 54(3), with additional cluster deployments envisioned for additional floors. With reference to FIGS. 2 and 3, the ultrasound beacon clusters 44(1)-44(A) are configured for deployment in the distributed communication system 40, which is also configured to downlink and uplink distributed communication signals 56D, 56U from base stations 58 and/or a network 60 to and from client devices 48. In this regard, a central unit 62 receives downlink communication signals 56D from the base stations(s) 58 and/or the network 60 for distribution of a communication media 64 to one or more remote units 66(1)-66(N). The remote units 66(1)-66(N) include at least one RF antenna 68(1), 68(2) configured to radiate the downlink communication signals 56D to the client devices 48. Multiple RF antennas 68(1), 68(2) may be provided for multiple input, multiple output (MIMO) communications. The remote units 66(1)-66(N) are also configured to receive uplink communication signals 56U from the client devices 48 to be distributed over the media 64 to the central unit 62, which are in turn provided to the base station(s) 58 and/or the network 60.

With continuing reference to FIGS. 2 and 3, the communication media 64 could be one medium or a plurality of a communications media, and/or any combination of different types. For example, the communication media 64 may be optical fiber cables, cables having electrical conductors, such as twisted-pair wiring or coaxial cable, combinations of optical and electrical transmission media, such as composite optical/metallic conductor cables, and other media. Frequency division multiplexing (FDM) or time division multiplexing (TDM) can be employed to provide the downlink and uplink communication signals 56D, 56U between the central unit 62 and the remote units 66(1)-66(N). Alternatively, separate, dedicated communication media 64 may be provided between the central unit 62 and the remote units 66(1)-66(N). Further, the downlink and uplink communication signals 56D, 56U could include digital data signals and/or RF communication signals.

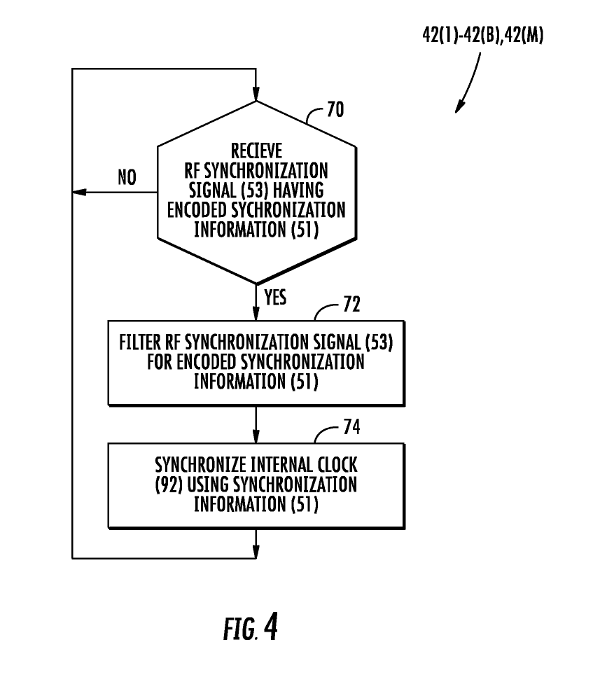

As discussed above with reference to FIG. 2, the ultrasound beacons 42(1)-42(B), 42(M) are synchronized, as opposed to having to synchronize the client devices 48 to the ultrasound beacons 42(1)-42(B), 42(M). The ultrasound beacons 42(1)-42(B), 42(M) are synchronized to each other so that the ultrasound pulses 46, 46(M) are emitted by the ultrasound beacons 42(1)-42(B), 42(M) in synchronization to the client devices 48. In this manner, the client devices 48 can distinguish between ultrasound pulses 46, 46(M) received from different ultrasound beacons 42(1)-42(B), 42(M). FIG. 4 illustrates an exemplary process of an ultrasound beacon 42(1)-42(B), 42(M) receiving RF synchronization signals 53 including synchronization information 51. The synchronization information 51 is used by the ultrasound beacons 42(1)-42(B), 42(M) to synchronize their internal clocks used to synchronize ultrasound pulse 46, 46(M) emission. Alternatively, the synchronization information 51 may be a central clock signal that is received by all ultrasound beacons 42(1)-42(B), 42(M) and used to synchronize ultrasound pulse 46, 46(M) emission.

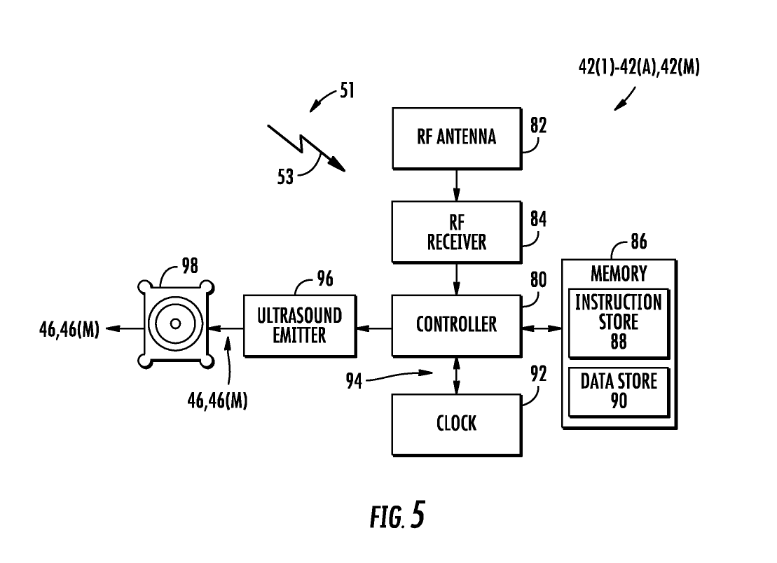

With reference to FIG. 4, a controller 80 of the ultrasound beacon 42(1)-42(B), 42(M), which is schematically illustrated in FIG. 5, determines if an RF synchronization signal 53 having encoded synchronization information 51 has been received (block 70 in FIG. 4). As illustrated in FIG. 5, the ultrasound beacon 42(1)-42(B), 42(M) includes an RF antenna 82 coupled to an RF receiver 84. The RF antenna 82 is configured to receive the RF synchronization signal 53 having the encoded synchronization information 51. For example, the RF synchronization signal 53 may be communicated using a radio frequency identification (RFID), Zigbee, or Dash7 protocols, as non-limiting examples. The RF antenna 82 is coupled to the RF receiver 84, which is configured to provide the encoded synchronization information 51 to the controller 80. The controller 80 is coupled to memory 86 that includes instruction store 88 and data store 90. The instruction store 88 contains instructions executed by the controller 80 to control the operations of the ultrasound beacon 42(1)-42(B), 42(M). The data store 90 allows the synchronization information 51 to be stored as well as other data, such as an identification indicia of the ultrasound beacon 42(1)-42(B), 42(M), as examples.

The controller 80 filters the RF synchronization signal 53 for the encoded synchronization information 51 (block 72 in FIG. 4). The controller 80 then uses the synchronization information 51 to synchronize an internal clock 92 in the ultrasound beacon 42(1)-42(B), 42(M), as illustrated in FIG. 5 (block 74 in FIG. 4). The internal clock 92 emits a clock signal 94 that is used by controller 80 to control the emission of ultrasound pulses 46, 46(M). The controller 80 is coupled to an ultrasound emitter 96 to emit the ultrasound pulses 46, 46(M), and the ultrasound emitter 96 is coupled to at least one speaker 98 that emits the ultrasound pulses 46, 46(M) as sound that can be received and recorded by the client devices 48. The client devices 48 use these pulses to perform time-difference-of-arrival analyses to determine their location within the distributed communication system 40.

As one synchronization example, the synchronization information 51 may be used by the ultrasound beacons 42(1)-42(B), 42(M) to emit ultrasound pulses 46, 46(M) in sequence. The sequence of ultrasound pulses 46, 46(M) arriving at a client device 48 is the same as the emission sequence to avoid temporal overlap of ultrasound pulses 46, 46(M). There is thus sufficient separation in the received ultrasound pulses 46, 46(M) for the client device 48 to distinguish the receipt of the ultrasound pulses 46, 46(M) as being emitted from particular ultrasound beacons 42(1)-42(B), 42(M). The client device 48 can determine its location by subtracting timing offsets from the ultrasound pulse 46, 46(M) arrival times to determine the relevant propagation-induced time-difference-of-arrival.

The ultrasound pulse 46, 46(M) emission time offsets may be configured based on the synchronization information 51 to be larger than the maximum propagation time possible. The maximum propagation time possible depends on size in which an ultrasound beacon cluster 44(1)-44(A) is disposed and the speed of sound at approximately 330 meters per second (m/s) (i.e., about 1 foot per millisecond (ms)). For example, the ultrasound beacons 42(1)-42(B), 42(M) may be configured to emit ultrasound pulses 46, 46(M) in approximately one millisecond (1 ms) durations to minimize or eliminate temporal overlap.

As another synchronization example, the ultrasound pulses 46, 46(M) could be emitted by different ultrasound beacons 42(1)-42(B), 42(M) simultaneously or substantially simultaneously with the different ultrasound beacons 42(1)-42(B), 42(M) emitting ultrasound pulses 46, 46(M) at different carrier frequencies. Temporal overlap of received ultrasound pulses 46, 46(M) by the client devices 48 can be tolerated since the ultrasound pulses 46, 46(M) are separated in the frequency domain. The client devices 48 can distinguish which ultrasound beacons 42(1)-42(B), 44(M) emitted which ultrasound pulses 46, 46(M) in a spectral analysis of the received ultrasound pulses 46, 46(M).

As another synchronization example, the ultrasound pulses 46, 46(M) could be emitted by different ultrasound beacons 42(1)-42(B), 42(M) and at different carrier frequencies. The sequence of ultrasound pulses 46, 46(M) arriving at a client device 48 is the same as the emission sequence and temporal overlap of ultrasound pulses 46, 46(M) is avoided. The client devices 48 can also distinguish which ultrasound beacons 42(1)-42(B), 42(M) emitted which ultrasound pulses 46, 46(M) in a spectral analysis of the pulses 46, 46(M). This example may be particularly useful for larger rooms or areas requiring a larger number of ultrasound beacons 42(1)-42(B), 42(M) to unambiguously associate ultrasound pulses 46, 46(M) as being emitted by particular ultrasound beacons 42(1)-42(B), 42(M).

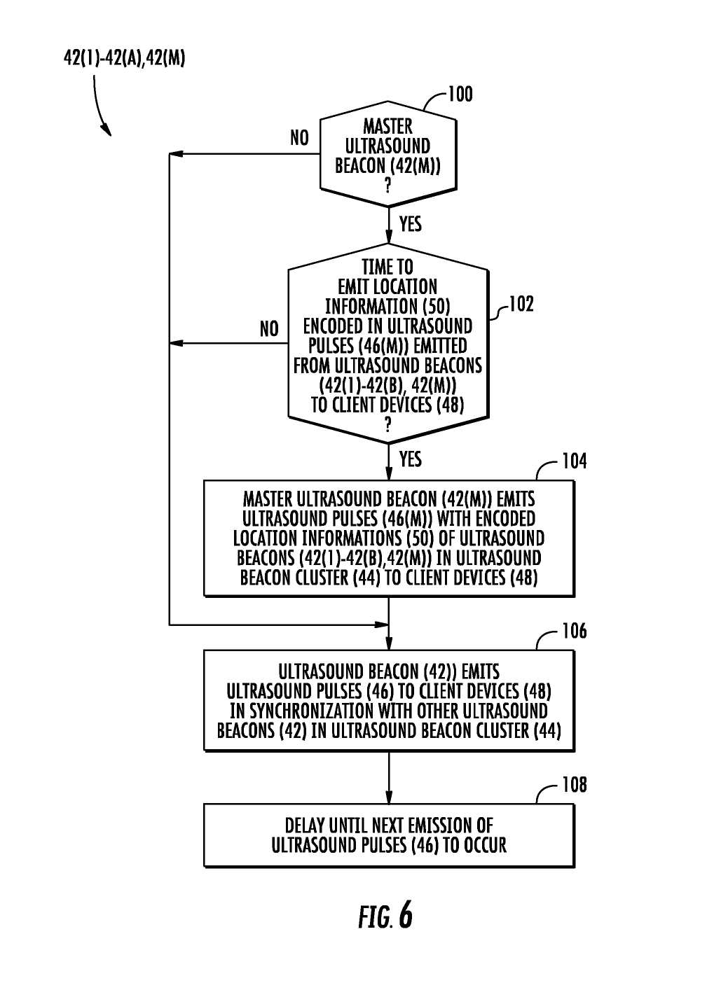

FIG. 6 is a flowchart illustrating an exemplary process of an ultrasound beacon 42(1)-42(B), 42(M) emitting ultrasound pulses 46, 46(M) to be received by the client devices 48. As discussed above, the master ultrasound beacon 42(M) is configured to encode location information 50 of all the ultrasound beacons 42(1)-42(B), 42(M) in ultrasound pulses 46(M) emitted by the master ultrasound beacon 42(M) to the client devices 48. For example, the location information 50 could be enclosed in a coding scheme, such as frequency-shift-keying (FSK) for example, or other coding schemes, using the ultrasound pulses 46(M) as an over-the-air interface. Thus, if the ultrasound beacon 42(1)-42(B), 42(M) is a master ultrasound beacon 42(M) (block 100 in FIG. 6), the master ultrasound beacon 42(M) determines if it is time to encode the location information 50 in ultrasound pulses 46(M) to be emitted to the client devices 48 (block 102 in FIG. 6). It may only be desired to periodically, and less often than normal emission of ultrasound pulses 46(M) for time-difference-of-arrival analysis, emit ultrasound pulses 46(M) encoded with the location information 50 to the client devices 48.

With continuing reference to FIG. 6, if it is time to encode the location information 50 in ultrasound pulses 46(M) to be emitted to the client devices 48 (block 102 in FIG. 6), the controller 80 of the master ultrasound beacon 42(M) causes the ultrasound emitter 96 in FIG. 5 to emit ultrasound pulses 46(M) with encoded location information 50 of the location of the ultrasound beacons 42(1)-42(B), 42(M) in the ultrasound beacon cluster 44 to the client devices 48 (block 104 in FIG. 6). Thereafter, regardless of whether the ultrasound beacon 42 is a master ultrasound beacon 42(M) or a non-master ultrasound beacon 42(1)-42(B), the controller 80 of the ultrasound beacon 42(1)-42(B), 42(M) controls emission of the ultrasound pulses 46(M) to be in synchronization with other ultrasound beacons 42(1)-42(B), 42(M) to the client devices 48 (block 106 in FIG. 6). The synchronization methods employed by the controller 80 can include any of the synchronization techniques previously described above to allow the client devices 48 to distinguish between which particular ultrasound beacons 42(1)-42(B), 42(M) the received ultrasound pulses 46, 46(M) were emitted. The controller 80 may delay the emission of the next ultrasound pulses 46, 46(M) by the ultrasound emitter 96 next depending on the synchronization method employed (block 108 in FIG. 6).

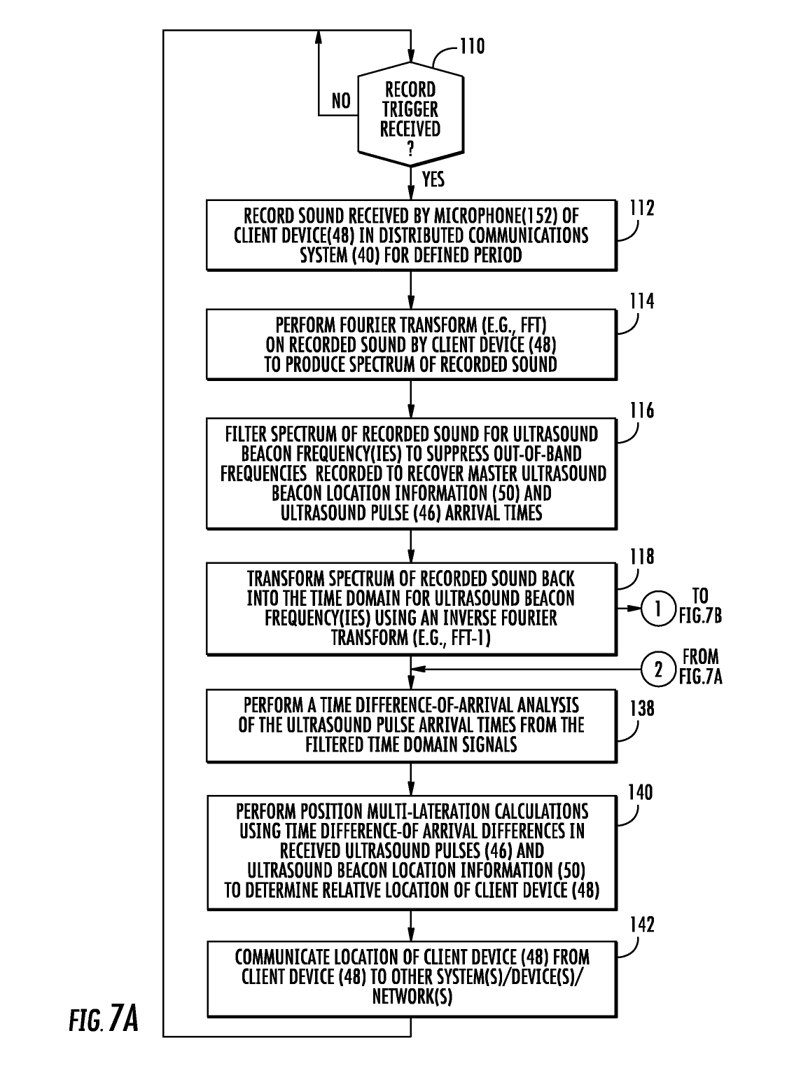

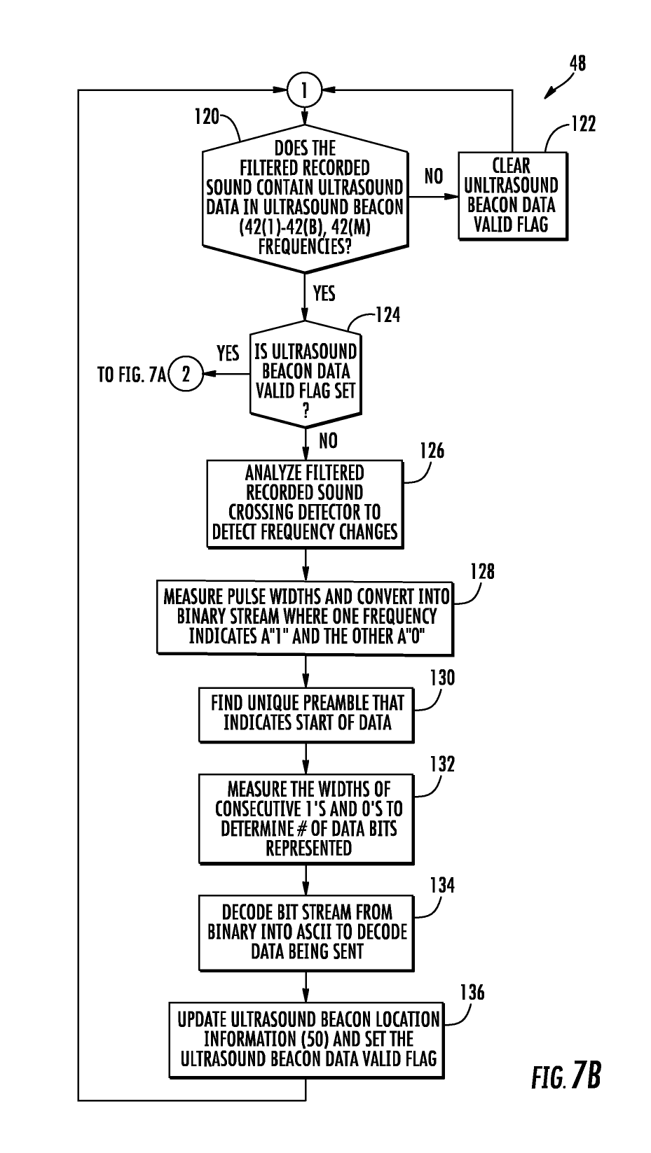

FIGS. 7A and 7B are flowcharts illustrating a process of the client device 48 receiving ultrasound pulses 46, 46(M) from ultrasound beacons 42(1)-42(B), 42(M) and using the time-difference-of-arrival of the received ultrasound pulses 46, 46(M) to determine location. FIG. 8 is a schematic diagram of a client device 48 discussed in conjunction with FIGS. 7A and 7B. With reference to FIG. 7A, a controller 150 of the client device 48 (FIG. 8) determines if it is time to record sound received by a microphone 152 coupled to an ultrasound receiver 154 to receive ultrasound pulses 46, 46(M) (block 110 in FIG. 7A). It may be desired for the controller 150 of the client device 48 to only determine location at particular times to conserve power or processing capability of the controller 150. It may also be desired of the controller 150 of the client device 48 to only record sound to receive ultrasound pulses 46, 46(M) when directed by a user through input 158 on a user interface 156 provided in the client device 48.

With continuing reference to FIG. 7A, if it is not time to record sound to receive ultrasound pulses 46, 46(M), the controller 150 continues to make this determination (block 110 in FIG. 7A) until it is time to record sound received by a microphone 152 coupled to an ultrasound receiver 154. When it is time to record sound, the controller 150 directs the ultrasound receiver 154 to receive sound received by the microphone 152 and record the sound in memory 160 for a defined period of time (block 112 in FIG. 7A). The memory 160 also contains the instructions that are executed by the controller 150 to perform the location determination operations discussed herein in this example. For example, these instructions may be provided in a location applet 162 stored in memory 160.

The ultrasound pulses 46, 46(M) are communicated by the ultrasound beacons 42(1)-42(B), 42(M) at one or more carrier frequencies. As discussed above, the ultrasound beacons 42(1)-42(B), 42(M) may be configured to emit ultrasound pulses 46, 46(M) on the same carrier frequency or different, unique carrier frequencies depending on whether ultrasound pulses 46, 46(M) are emitted in sequence synchronization or in simultaneous emission synchronization. Thus, the controller 150 is configured in this example to convert the recorded sound into a frequency domain by performing a Fourier transform on the recorded sound to produce a spectrum of the recorded sound (block 114 in FIG. 7A). The controller 150 then filters the spectrum of recorded sound for the expected ultrasound beacon 42(1)-42(B), 42(M) carrier frequency(ies) to recover the location information 50 of the ultrasound beacons 42(1)-42(B), 42(M) and the ultrasound pulse 46, 46(M) arrival times (block 116 in FIG. 7A). Out-of-band frequencies may be filtered out of the recorded sound since the microphone 152 will pick up other surrounding environmental noise, including ambient noise in the recorded sound (block 116 in FIG. 7A).

With continuing reference to FIG. 7A, the controller 150 of the client device 48 then transforms the spectrum of recorded sound back into the time domain via a reverse Fourier transform so that the recorded sound can be analyzed in the time domain for time difference-of-arrival (block 118 in FIG. 7A). The client device 48 performs the process in FIG. 7B to process the filtered recorded sound to determine if location information 50 for the ultrasound beacons 42(1)-42(B), 42(M) is present in the filtered recorded sound. This processing example is shown assuming the location information 50 is encoded in the ultrasound pulses 46, 46(M) using FSK (Frequency Shift Key) encoding, but other encoding schemes could be employed, such as ASK (Amplitude Shift Keying) and PSK (Phase Shift Keying).

The client device 48 checks to see if the filtered, recorded sound transmission contains ultrasound pulses or data at the expected carrier frequency(ies) of the ultrasound beacons 42(1)-42(B), 42(M) (block 120 in FIG. 7B). If not, an ultrasound beacon data valid flag can be cleared in memory 160 of the client device 48 indicating that data expected to contain location information 50 is not present in the filtered recorded sound (block 122 in FIG. 7B). The process continues to check to determine whether the filtered recording sound transmission contains data expected to contain location information 50 (block 120 in FIG. 7B). When data is detected in the filtered recorded sound (block 120 in FIG. 7B), the client device 48 checks to determine whether the ultrasound beacon 42(1)-42(B), 42(M) locations are already known from prior received filtered recorded sound from the ultrasound beacon 42(1)-42(B), 42(M) by checking the ultrasound beacon data valid flag in memory 160 (block 124 in FIG. 7B). If set, the process returns to block 138 in FIG. 7A to continue with time-difference-of-arrival analysis, since location information 50 has been previously received and stored in memory 160 for use in time-difference-of-arrival analysis. If not set, the filtered recording sound is analyzed to recover the location information 50 for use by the client device 48 to perform time-difference-of-arrival analysis using a software zero crossing detector, which outputs an array in memory 160 that indicates the pulse width of signal above zero and below zero (block 126 in FIG. 7B).

With continuing reference to FIG. 7B, this array indicative of pulse width of signal above zero and below zero can then be passed to a routine, that measures the pulse widths and builds a binary array that indicates if the ultrasound waveform period was representative of a one or zero when encoded (block 128 in FIG. 7B). This array is then passed to a routine that looks for a preamble (indicated by a stream of ones longer than a single transmitted byte) (block 130 in FIG. 7B). The binary data present after the preamble is the desired data, which is a series of ones and zeros in which there are two (2) entries for one (1) cycle of the encoded frequency burst in this example (block 132 in FIG. 7B). The widths of the binary data are measured, and the original encoded binary data is reconstituted (block 134 in FIG. 7B). This binary data has all framing bits removed, and is converted to ASCII (block 134 in FIG. 7B). The ultrasound beacon 42(1)-42(B), 42(M) locations are determined from the data received, either directly (i.e. GPS coordinates were sent) or indirectly (i.e. a database key was sent, a lookup performed, and the coordinates are populated as the location information 50 (block 136 in FIG. 7B).

With reference back to FIG. 7A, with location information 50 obtained from ultrasound beacons 42(1)-42(B), 42(M), the controller 150 then performs a time-difference-of-arrival analysis of the received ultrasound pulses 46, 46(M) from the filtered recorded sound in the time domain (block 138 in FIG. 7A). The controller 150 determines its distance from the ultrasound beacons 42(1)-42(B), 42(M) in which ultrasound pulses 46, 46(M) are received based on associating the time-difference in the arrival of the ultrasound pulses 46, 46(M) with particular pairs of ultrasound beacons 42(1)-42(B), 42(M). Examples of time-difference-of-arrival analysis can be found in K. C. Ho and Y. T. Chan, IEEE Transactions on Aerospace and Electronic Systems, Vol. 29, No. 4, October 1993, pp. 1311-1322, which is incorporated herein by reference in its entirety. This time-difference-of-arrival analysis provides the relative distance of the client device 48 from the ultrasound beacons 42(1)-42(B), 42(M) in which ultrasound pulses 46, 46(M) are received. The controller 150 of the client device 48 then performs position multi-lateration calculations using the time-difference-of-arrival information from the received ultrasound pulses 46, 46(M) and the location information 50 of the ultrasound beacons 42(1)-42(B), 42(M) to determine the relative location of the client device 48 to the ultrasound beacons 42(1)-42(B), 42(M) (block 140 in FIG. 7A). This relative location can be determined if ultrasound pulses 46, 46(M) from at least two (2) ultrasound beacons 42(1)-42(B), 42(M) are received by the client device 48. This relative location may be only relative to the location information 50 of the ultrasound beacons 42(1)-42(B), 42(M) provided to the client device 48. Location information 50 from two ultrasound beacons 42(1)-42(B), 42(M) allows the client device 48 to determine a boundary of possible locations of the client device 48. Location information 50 from three (3) or more ultrasound beacons 42(1)-42(B), 42(M) allows the client device 48 to determine exact locations relative to the two ultrasound beacons 42(1)-42(B), 42(M). The relative location can be an absolute (i.e., non-relative) location (e.g., coordinates, also e.g., X, Y, and/or Z (i.e., longitude, latitude, and/or altitude) coordinates) if the location information 50 of the ultrasound beacons 42(1)-42(B), 42(M) provided to the client device 48 are absolute locations.

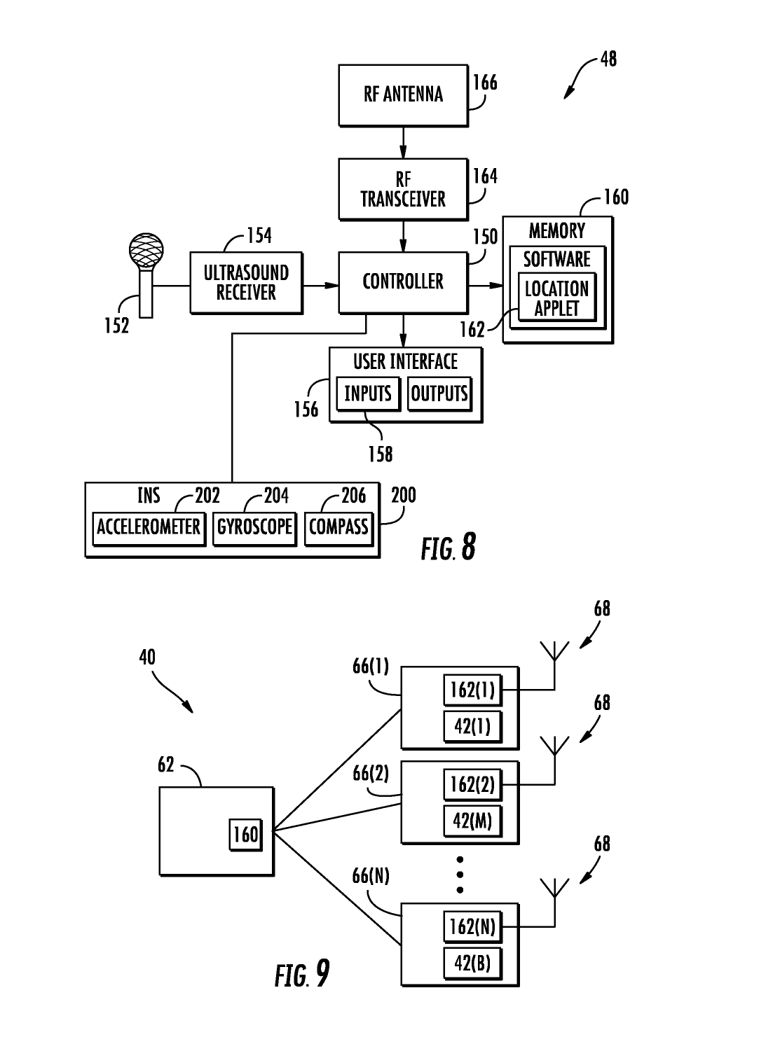

With continuing reference to FIG. 7A, the client device 48 can store its determined location in memory 160 and/or communicate the location to another device or network (block 142 in FIG. 7A). As illustrated in FIG. 8, a client device 48 includes an RF transceiver 164 and an RF antenna 166. The client device 48 can transmit the determined location wirelessly through the RF transceiver 164 and the RF antenna 166 to another device or network. For example, the client device 48 can transmit the determined location to a remote unit 66(1)-66(N) in the distributed communication system 40 in FIG. 2. Thus, the client device 48 could use the distributed communication system 40 to distribute its determined location as well as for other wireless functions. The identification of the client device 48 may also be included in this RF communication. The remote unit 66(1)-66(N) could distribute the location of the client device 48 as an uplink communication signal 56U to the central unit 62. The determined location of the client device 48 can be stored in memory 150 of the central unit 62, as illustrated in FIG. 9, and then forwarded to a base station 58 and/or the network 60. The process can repeat by returning back to block 110 in FIG. 7A until the next recording is triggered by the controller 150.

As discussed above and illustrated in FIG. 2, the ultrasound beacons 42(1)-42(B), 42(M) are provided in the distributed communication system 40 apart from other components in the distributed communication system 40. However, the ultrasound beacons 42(1)-42(B), 42(M) could be co-located and/or included in the other components and/or their housings in the distributed communication system 40. For example, as illustrated in FIG. 9, the ultrasound beacons 42(1)-42(B), 42(M) are shown as co-located and included in the remote units 66(1)-66(N). In this manner, if the determined locations of the client devices 48 are provided to the remote unit 66(1)-66(N), wireless RF communication through the RF antenna 68 coupled to an RF interface 152(1)-152(N) in the remote units 66(1)-66(N) to do so would not be necessary. The beacons 42(1)-42(B), 42(M) could provide the determined location information of the client devices 48 to the remote unit 66(1)-66(N) over wired connections/interfaces. Further, in this arrangement, if the synchronization information 51 is provided through the remote units 66(1)-66(N) to the beacons 42(1)-42(B), 42(M), RF communication would not be necessary because synchronization information 51 could be provided through wired connections/interfaces from the remote units 66(1)-66(N) to the beacons 42(1)-42(B), 42(M).

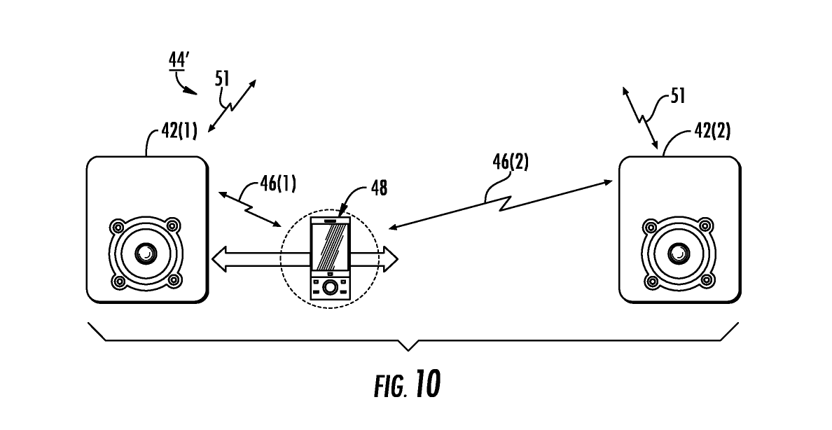

FIG. 10 illustrates an ultrasound cluster 44′ having only two ultrasound beacons 42(1) and 42(2). This embodiment is particularly well-suited for use in building hallways. The received information 51 may include the reference clock signal, and the ultrasound signals 46(1) and 46(2) are used by the client device 48 to calculate a first position as previously described. While this embodiment is well-suited for use in corridors of buildings, ultrasound pulses are not likely to penetrate walls and enter rooms to either side of the corridor. Thus, the client device 48 needs some alternate method through which it may continue to calculate a current position within the building.

In one such embodiment, a client device 48 uses an inertial navigation system (INS) to navigate in spaces where ultrasound beacons may not be available. The client device 48 schematically illustrated in FIG. 8 includes such an INS 200. In an exemplary embodiment, the INS 200 includes an accelerometer 202, a gyroscope 204 and a compass 206. Many conventional smart phones include these elements and/or comparable INS elements. While only one accelerometer 202 and one gyroscope 204 are illustrated, it should be appreciated that in some embodiments, a plurality of such devices may be present and aligned on one or more orthogonal axes. Thus, in an exemplary embodiment, there may be three accelerometers 202 and three gyroscopes 204.

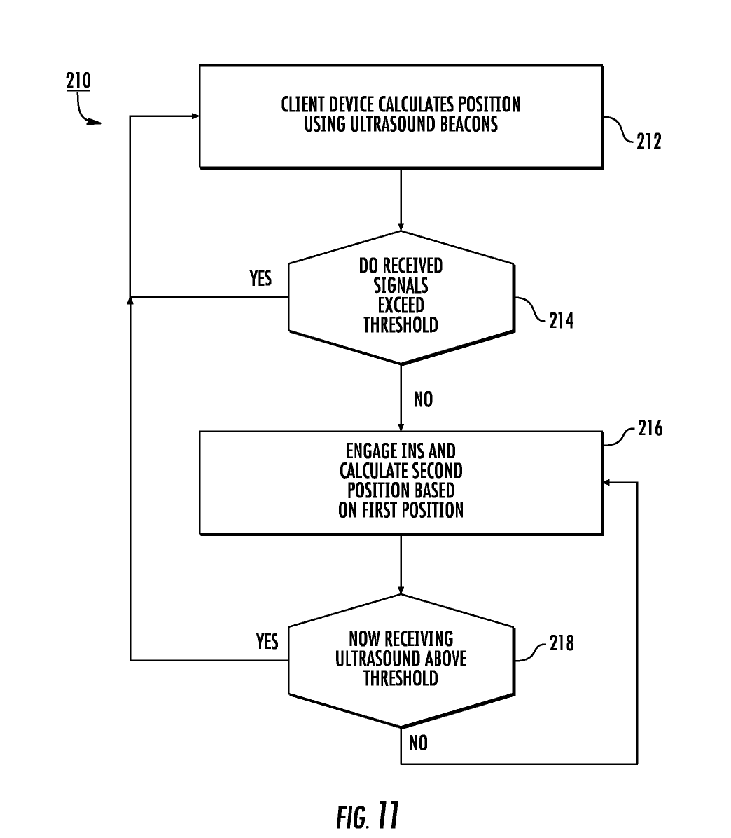

An exemplary methodology 210 for using the INS 200 is illustrated in FIG. 11. The client device 48 initially determines its position using signals received from the ultrasound beacons 42(1) and 42(2) (block 212). The position calculated from the ultrasound signals may be considered a first position. The client device 48 moves within the building and monitors to see if the received ultrasound signals exceed a predetermined threshold (block 214). The predetermined threshold corresponds to a signal strength sufficient from which to extract meaningful data. If the answer to block 214 is yes, the signal strength remains above the threshold, and the client device 48 then calculates its position using the signals from the ultrasound beacons 42. If the client device 48 moves enough, it may be passed to a different ultrasound cluster 44 or different ultrasound beacons 42.

If the answer to block 214 is ‘no’, the ultrasound signal strength has fallen below a predefined threshold, then the client device 48 initiates use of the INS 200 to calculate a second position (block 216) using the first position from the ultrasound beacons 42 as a starting point. Use of an INS 200 is well understood as evidenced by the work of D. H. Titterton and J. Weston in Strapdown Inertial Navigation Technology, published by American Institute of Aeronautics and Astronautics, Second Edition, 2004. If at a subsequent time, the client device 48 begins receiving ultrasound signals above the predefined threshold, then the client device may return to block 212 and calculate a current position using the ultrasound signals. Otherwise, the client device 48 continues to use the INS 200 to determine its current position.

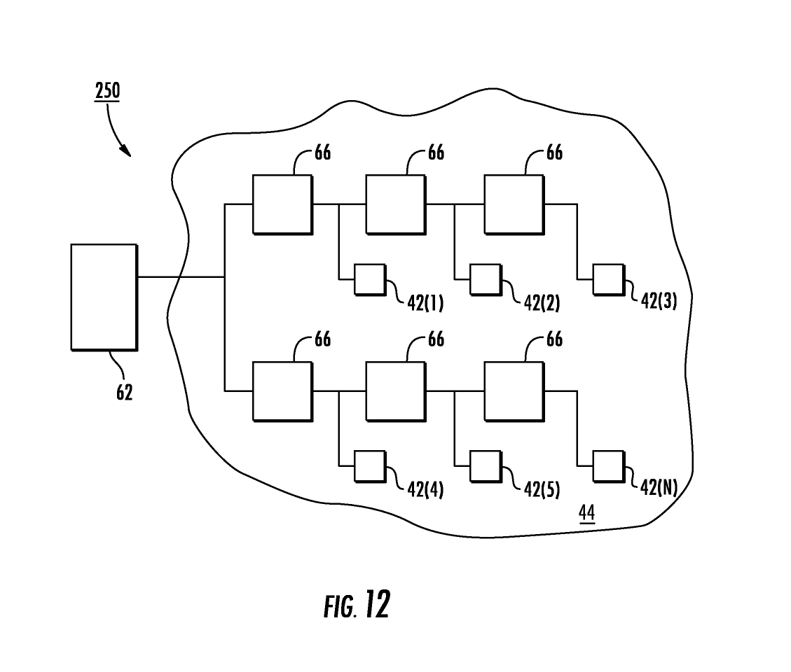

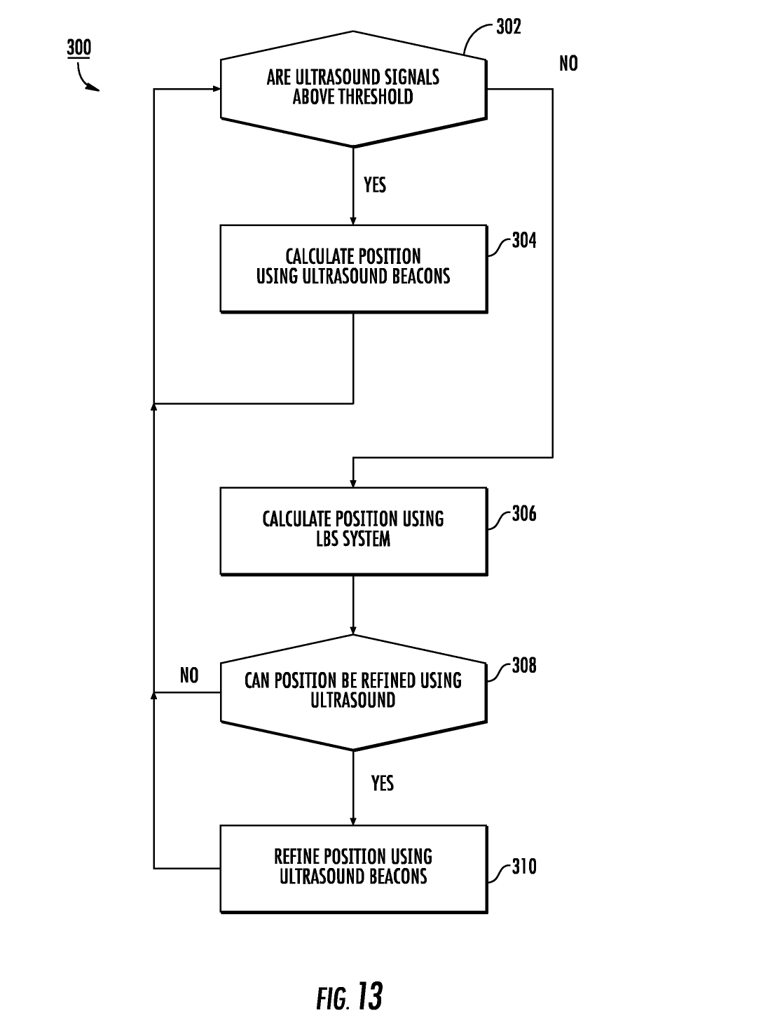

In an alternate embodiment, the ultrasound techniques of the present disclosure are used to assist other location based services (LBS) and systems supporting such LBS to pinpoint a location of a client device. That is, there are times when an LBS may not be able to pinpoint a location of a client device with sufficiently fine resolution. Thus, an ultrasound system may be concurrently deployed to supplement the location determination. FIGS. 12 and 13 respectively illustrate a schematic diagram and a flow chart of such ultrasound assistance in a location determination system 250. The location determination system 250 includes a central unit 62 with a distributed communication system formed by remote units 66, which may include WLAN communication elements including location based services systems for WLAN systems. In addition to the remote units 66, the distributed communication system may include ultrasound beacons 42(1)-42(N). The ultrasound beacons 42 may be in direct communication with the location determination system 250 (illustrated) or a separate system (not illustrated) as desired. It should be appreciated that the structure of the building in which the location determination system 250 is installed may create zones where the location determination elements of the WLAN components are inadequate to ascertain a location of a client device with sufficient particularity. In this case, the ultrasound elements may be used to provide supplementary location information and the client device may use whichever system provides a better location resolution as desired and as further explicated with reference to FIG. 13.

FIG. 13 illustrates a method 300 that begins with ascertaining whether the signal strength of the ultrasound signals from the ultrasound beacons 42 is above a predefined threshold (block 302). If the answer is ‘yes’, then the client device 48 calculates its position using the ultrasound beacons (block 304). Additionally, the client device 48 may report its current position to the central unit 62 through the remote units 66 as appropriate and/or as available. If the answer to block 302 is ‘no’—the signal strength of the ultrasound signals is not above the predefined threshold—then the client device 48 calculate its position using the signals from WLAN elements such as remote units 66 (block 306). The client device 48 may monitor both the signals from the remote units 66 and the ultrasound beacons 42 to ascertain whether a position can be refined using the ultrasound signals (block 308). If the position can be refined, then the position is refined using the ultrasound signals (block 310). Again, this refined position may be reported to the system through the remote units 66 as desired. If the position cannot be refined, the process repeats as indicated. In essence, the embodiment of FIGS. 12 and 13 uses the better of the two location systems to assist the client device 48 to obtain the best available location information.

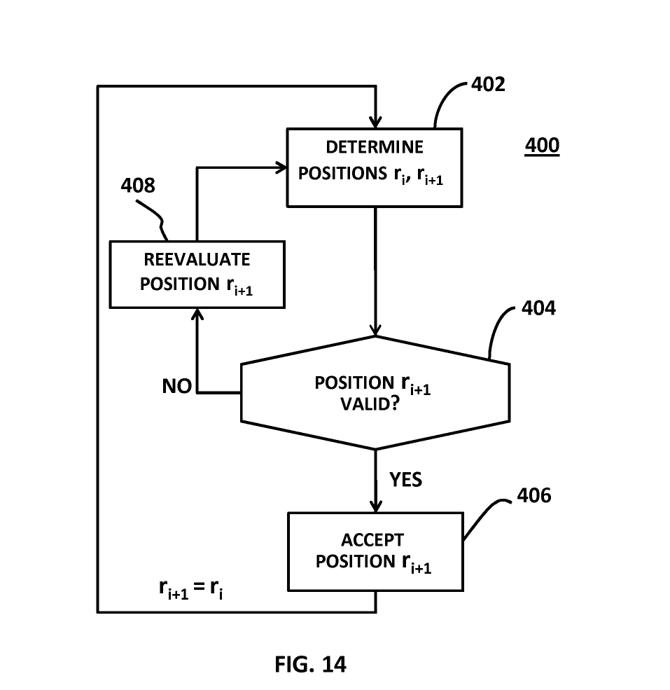

FIG. 14 is a flowchart illustrating an embodiment of a method for monitoring and improving the accuracy of client device location calculations. In some instances, individual position measurements based on inertial calculations, for example, may exhibit relatively large errors, particularly as inertial data is gathered over time. Position information from ultrasound localization systems can also occasionally experience relatively large errors, such as when an obstruction in the beacon environment disrupts the transmit path for ultrasound bursts. The position errors such schemes may experience may be in the range of several meters. According to one aspect of the present embodiment, such error events can be filtered out and/or accounted for if the position change from a first established position to a second position is determined as being physically impossible or at least improbable. In accordance with another aspect, the position data from one localization method, such as ultrasound localization, can be compared with position data from another method, such as INS calculations by the INS 200 (FIG. 8) in the client device 48. When the comparison between differing localization methods fails to satisfy specified parameters, a position determination may be deemed ‘invalid’. Invalid positions can be reevaluated and compensated for by various methods as described in further detail below.

Referring to FIG. 14, in block 402, a first position rᵢ and a second position rᵢ₊₁ are used in the process for improving the accuracy of client device location calculations. The first and second positions rᵢ, rᵢ₊₁ can be determined as, for example, consecutive position determinations provided by any of the ultrasound localization methods and apparatuses disclosed in this specification. Alternatively, the first position rᵢ could be obtained from ultrasound beacon data, and the second position rᵢ₊₁ could be obtained by inertial data. This situation may arise when the client device 48 moves from a first position within range of ultrasound beacons 42(1)-42(B), 42(M) (FIG. 3) to a second position that is not accessible to ultrasound beacons, and thus relies on the INS 200 for position determination. In yet another embodiment, the first and second positions rᵢ, rᵢ₊₁ can be calculated as consecutive measurements obtained from the INS 200.

The validity of the second position is evaluated in block 404. If, for example, rᵢ and rᵢ₊₁ are determined by an ultrasound localization system, such as the system 40 shown in FIG. 3, the validity of the second position rᵢ₊₁ can be compared with inertial information obtained from the INS 200 in the client device 48 (FIG. 8). In this example, the validity of the second position rᵢ₊₁ is evaluated by comparing the distance the client device 48 must travel in moving from rᵢ to rᵢ₊₁ with position information determined by the INS 200. The following equation is satisfied if the position information from the ultrasound localization system (the left side of the equation) agrees with the INS 200 (the right side of the equation):

\vec{r}ᵢ₊₁−\vec{r}ᵢ=\vec{v}ᵢΔt+∫∫ₜ_{ᵢ}^{t}^{ᵢ₊₁}\vec{α}(t)dt

where t=time, vᵢ=speed at the first position, and a=acceleration as measured by the INS 200.

In three-dimensional space, the quantities used in this equation are vectors. If the second position determined from the ultrasound calculation deviates significantly from that calculated by the INS 200, the position measurement rᵢ₊₁ can be deemed invalid. The significance of the variation in positions can be established by various criteria. For example, a predetermined maximum linear distance difference between the two calculations can serve as the allowable deviation. For relatively fine error correction, a distance difference of one meter or more can indicate an invalid calculation of the second position. For coarser error calculations, a distance difference of two or more meters can be used to indicate an invalid calculation of the second position. A maximum percentage deviation between the two values could also serve as the allowable deviation. A combination of distance and percentage deviation could also serve as the allowable deviation.

Vector calculations are more accurate than scalar calculation and may be more desirable under some circumstances. However, a less sensitive but computationally faster invalidity test involves using the absolute values of the quantities r, v, and a in the equation. In this case, the equation can be restated as an inequality. The right hand side INS calculation may, for example, serve as an upper limit for the position change (rᵢ₊₁−rᵢ) predicted by ultrasound information, which in most cases will be smaller than the position change predicted by the INS 200. If the distance of a position change determined through ultrasound localization exceeds the distance determined using INS, the ultrasound calculation can be deemed invalid.

Another way to determine the validity of the second position rᵢ₊₁ is to determine the velocity required for the client device 48 to travel from the first position rᵢ to the second position rᵢ₊₁. In other words, the distance traveled (rᵢ₊₁−rᵢ) is divided by time t to determine the average velocity necessitated by the calculated movement. If that velocity is higher than a reference velocity vᵣ, the new location is determined to be invalid. The reference velocity vᵣ can be calculated, for example, based on an expected upper velocity that an average person can travel in the environment in which the client device is moving. If the initial velocity vᵢ is aligned, wholly or partially, with the direction of travel corresponding to moving to the second position rᵢ₊₁, the reference velocity vᵣ can be adjusted to a higher value because the movement represents a continuation of the client device 48 movement at the first position rᵢ. The reference velocity vᵣ may be adjusted downwardly when vᵢ indicates the client devices is moving away from the second position rᵢ₊₁ at tᵢ.

According to one aspect, the reference velocity may be tailored to the user of a specific client device. For example, the mobile device 48 can be configured to receive personal information for the device owner such as age, height, sex, mobility, and other information, which can then be used to calculate that person's reference velocity. The client device 48 can also be programmed to learn and record the user's movement habits through certain environments and to adjust the reference velocity based on such criteria.

Still referring to FIG. 14, if the second position is determined to be valid, the second position is accepted by the client device 48 as the current position. Position rᵢ₊₁ may then be used as rᵢ in a subsequent iteration of the error monitoring process beginning at block 402. The subsequent position rᵢ₊₁ can be input as, for example, position data calculated by the INS 200, or position data determined using ultrasound beacon information.

If in block 404 the second position rᵢ₊₁ is determined to be not valid, the position information is reevaluated. The position information can be, for example, discounted by weighting the movement vector components from rᵢ to rᵢ₊₁ by a value less than 1. If, for example, the average velocity required for the client device 48 to move from rᵢ to rᵢ₊₁ is 50% higher than a maximum reasonable velocity for that environment, the position vectors can be discounted by a factor of, for example, 0.5, to generate an ‘adjusted position’ rᵢ₊₁. According to another aspect, the adjusted position is calculated as a weighted sum of the first and second positions rᵢ, rᵢ₊₁. For example, the movement vectors describing the first position rᵢ can be multiplied by a factor α and the movement vector describing the second position rᵢ₊₁ can be multiplied by a factor β. In one weighting scheme, the sum of α and β is equal to one (1).

Referring also to FIG. 3, if the client device 48 location is being tracked using ultrasound information from ultrasound beacons 42(1)-42(B), 42(M), and ultrasound beacons are available for position determination of the client device 48, a determination in block 404 that he second position rᵢ₊₁ is invalid can be used to trigger an immediate reacquisition by the client device 48 of location information from one of the ultrasound beacons 42(1)-42(B), 42(M). That updated position can then be evaluated using the process shown in FIG. 14 until acceptable position information is obtained. The validity of the position determined in response to a request to reacquire the client device position can in turn be determined That position can be ignored, accepted, or modified by, for example, weighting, as discussed above.

If ultrasound beacons are not available, and the client device position 48 is tracked solely through the INS 200, the second position can be evaluated using the criterion of a reference value vᵣ for the maximum velocity expected for a client device user to travel over a given time. As in previous methodologies, the validity of the second position can be determined, and the second position can be ignored, accepted, or modified by, for example, weighting, as discussed above.

According to the above-described embodiments, occasional large errors in position determinations can be reduced, suppressed, or altogether eliminated. For example, the INS 200 can be used to reduce the impact of occasional large errors in position determinations generated using the ultrasound localization system. Ultrasound localization systems are more prone to isolated, large errors, such as when the ultrasound transmission path provides erroneous reflections of ultrasound pulses, while INS systems are not subject to error based on such considerations. By contrast, INS systems are most prone to errors as they track client device movement over extended periods of time. The use of ultrasound beacon information is thus advantageous in that it can provide a mobile device with periodic checks, or ‘dead reckoning’ measurements, that can be used to correct and/or supplement NS data.

In the above-described embodiments, in some cases position determinations are evaluated with respect to ‘reference velocities’. This term is intended to encompass calculations that are based on established distances to be traveled, when such distances are indexed with respect to a fixed time period.

As discussed above, the ultrasound beacons 42(1)-42(B), 42(M) and client devices 48 execute instructions from a computer-readable medium (i.e., instructions in memory). The term “computer-readable medium” should be taken to include a single medium or multiple media (e.g., a centralized or distributed database, and/or associated caches and servers) that store the one or more sets of instructions. The term “computer-readable medium” shall also include any medium that is capable of storing, encoding or carrying a set of instructions for execution by the processing device and that cause the processing device to perform any one or more of the methodologies of the embodiments disclosed herein. The term “computer-readable medium” shall accordingly include solid-state memories, optical and magnetic media, and carrier wave signals.

The distributed communications systems disclosed in this specification are configured to provide digital data services. Examples of digital data services provided with digital data signals include, but are not limited to, Ethernet, WLAN, WiMax, WiFi, Digital Subscriber Line (DSL), and LTE, etc. Ethernet standards could be supported, including but not limited to 100 Megabits per second (Mbs) (i.e., fast Ethernet) or Gigabit (Gb) Ethernet, or ten Gigabit (10G) Ethernet. Examples of RF communication services provided with RF communication signals include, but are not limited to, US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink), and medical telemetry frequencies.

The embodiments disclosed herein include various steps that may be performed by hardware components or embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.), a machine-readable transmission medium (electrical, optical, acoustical or other form of propagated signals (e.g., carrier waves, infrared signals, digital signals, etc.)), etc.

Unless specifically stated otherwise, discussions utilizing terms such as “processing,” “computing,” “determining,” “displaying,” or the like, refer to processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. A variety of programming languages may be used to implement the teachings of the embodiments described herein.

The various illustrative logical blocks, modules, circuits, and algorithms described in connection with the present embodiments may be implemented as electronic hardware, instructions stored in memory or in another computer-readable medium and executed by a processor or other processing device, or combinations of both. The components of the distributed antenna systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps are described generally in terms of their functionality.

The logical blocks, modules, and circuits described in connection with the embodiments disclosed herein may be implemented with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor, which may be a microprocessor or any conventional processor, controller, microcontroller, or state machine.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other known form of computer-readable medium. An exemplary storage medium is coupled to the processor such that the processor can read information from, and write information to, the storage medium. Alternatively, the storage medium may be integral to the processor. The processor and the storage medium may reside in an ASIC, which may reside in a remote station. Alternatively, the processor and the storage medium may reside as discrete components in a remote station, base station, or server.

The operational steps described in any of the embodiments herein are described to provide examples and discussion, and may be performed in different sequences other than the illustrated sequences. Operations described in a single step may actually be performed in a number of different steps, and one or more operational steps may be combined. Data, instructions, commands, information, bits, symbols, and chips that may be referenced throughout the above description may be represented by voltages, currents, electromagnetic waves, magnetic fields or particles, optical fields or particles, or any combination thereof

The terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets, or the like.

The antenna arrangements disclosed herein may include any type of antenna desired, including but not limited to dipole, monopole, bowtie, inverted F, wireless cards, and slot antennas. The distributed antenna systems disclosed herein could include any type or number of communication media, including but not limited to electrical conductors, optical fiber and optical cable, and air (i.e., wireless transmission).

Various modifications and variations can be made without departing from the scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A method of an RF communication client device configured to communicate in a distributed communication system for determining location within the distributed communication system, comprising:
calculating a first position of the client device;
calculating a second position of the client device;
evaluating the validity of the second position with respect to the first position; and
if the second position is found to be invalid, reevaluating the second position, wherein
evaluating the validity of the second position comprises determining whether a velocity required to move from the first position to the second position exceeds a reference velocity.

2. The method of claim 1, wherein the first position is calculated using ultrasound signals received at the client device.

3. The method of claim 2, wherein calculating the first position comprises:
recording sound received from a plurality of ultrasound beacons over at least one microphone;
filtering the recorded sound about at least one ultrasound beacon frequency;
recovering a plurality of ultrasound pulses from the filtered recorded sound;
performing a time-difference-of-arrival analysis on the recovered plurality of ultrasound pulses; and
determining a relative distance of the client device to the plurality of ultrasound beacons.

4. The method of claim 3, further comprising:
recovering location information of a master ultrasound beacon from the filtered recorded sound; and
determining a relative location of the client device to the master ultrasound beacon based on applying the location information to the relative distance.

5. The method of claim 3, wherein the second position is calculated using an inertial navigation system within the client device.

6. The method of claim 5, wherein the inertial navigation system calculates the second position when a signal strength of an ultrasound signal received by the client device falls below a predetermined threshold.

7. The method of claim 2, wherein the second position is calculated using ultrasound signals received at the client device.

8. The method of claim 1, wherein the first position and the second position are calculated using an inertial navigation system within the client device.

9. The method of claim 2, wherein the reference velocity is selected according to at least one of the following user factors: age, sex, and height.

10. The method of claim 2, wherein reevaluating the second position comprises calculating an adjusted position by weighting the second position, and wherein calculating the adjusted position comprises calculating a sum of the first position weighted by a first factor and the second position weighted by a second factor.

11. The method of claim 8, wherein reevaluating the second position comprises using ultrasound signals received at the client device to calculate an updated position.

12. The method of claim 2, wherein the distributed communication system comprises a plurality of remote units having an RF antenna, the method further comprising, at the client device:
receiving RF communication signals from one or more of the remote units; and
transmitting RF communications signals to one or more of the remote units.

13. A method of an RF communication client device configured to communicate in a distributed communication system, the distributed communication system comprising a plurality of remote units configured for RF communications, for determining location within the distributed communication system, comprising:
calculating a first position of the client device;
calculating a second position of the client device;
evaluating the validity of the second position with respect to the first position; and if the second position is found to be invalid, reevaluating the second position, wherein:
the first position is calculated using ultrasound signals received at the client device;
the second position is calculated using ultrasound signals received at the client device;
evaluating the validity of the second position with respect to the first position comprises comparing position information from the ultrasound signals with position information from an inertial navigation system within the client device;
receiving RF communication signals from one or more of the remote units; and
transmitting RF communications signals to one or more of the remote units.

14. The method of claim 13, wherein calculating the first position comprises:
recording sound received from a plurality of ultrasound beacons over at least one microphone;
filtering the recorded sound about at least one ultrasound beacon frequency;
recovering a plurality of ultrasound pulses from the filtered recorded sound;
performing a time-difference-of-arrival analysis on the recovered plurality of ultrasound pulses; and
determining a relative distance of the client device to the plurality of ultrasound beacons.

15. The method of claim 14, further comprising:
recovering location information of a master ultrasound beacon from the filtered recorded sound; and
determining a relative location of the client device to the master ultrasound beacon based on applying the location information to the relative distance.

16. The method of claim 13, wherein comparing position information from the ultrasound signals with position information from an inertial navigation system comprises comparing a distance of travel calculated using the inertial navigation system with a distance calculated from the first position and the second position.

17. The method of claim 16, wherein the second position is invalid when the distance of travel calculated using the inertial navigation system differs from the distance calculated from the first position and the second position by at least a predetermined distance.

18. The method of claim 16, wherein the second position is invalid when the distance of travel calculated using the inertial navigation system differs from the distance calculated from the first position and the second position by at least a predetermined percentage.

19. The method of claim 16, wherein the second position is invalid when the distance of travel calculated using the inertial navigation system is less than the distance calculated from the first position and the second position.

20. The method of claim 13, wherein comparing position information from the ultrasound signals with position information from an inertial navigation system comprises comparing the second position calculated from ultrasound signals with a second position calculated using the inertial navigation system.

21. The method of claim 20, wherein the second position is invalid when the second position calculated from ultrasound signals differs from the second position calculated using the inertial navigation system by at least a predetermined value.

22. The method of claim 20, wherein reevaluating the second position calculated using ultrasound signals comprises calculating a sum of the first position using ultrasound signals weighted by a first factor and another position weighted by a second factor.

23. The method of claim 20, wherein reevaluating the second position calculated using ultrasound signals comprises using ultrasound signals received at the client device to calculate an updated position.

24. A method of an RF communication client device configured to communicate in a distributed communication system, the distributed communication system comprising a plurality of remote units configured for RF communications, for determining location within the distributed communication system, comprising:
calculating a first position of the client device;
calculating a second position of the client device;
evaluating the validity of the second position with respect to the first position; and if the second position is found to be invalid, reevaluating the second position, wherein
the first position is calculated using an inertial navigation system within the client device;
the second position is calculated using the inertial navigation system; and
evaluating the validity of the second position with respect to the first position comprises comparing position information from ultrasound signals received at the client device with position information from the inertial navigation system.

25. The method of claim 24, wherein comparing position information from the ultrasound signals with position information from the inertial navigation system comprises comparing a distance of travel calculated using the position information from the ultrasound signals with a distance calculated from the first position and the second position.

26. The method of claim 25, wherein the second position is invalid when the distance of travel calculated using the position information from the ultrasound signals differs from the distance calculated from the first position and the second position by at least a predetermined percentage.

27. The method of claim 25, wherein the second position is invalid when the distance of travel calculated using the position information from the ultrasound signals differs from the distance calculated from the first position and the second position by at least a predetermined distance.

28. The method of claim 24, further comprising:
receiving RF communication signals from one or more of the remote units; and
transmitting RF communications signals to one or more of the remote units, wherein
the distributed communication system comprises a plurality of ultrasound beacons, at least one of the ultrasound beacons being co-located with at least one of the remote units, the method further comprising, at the client device, receiving ultrasound signals from one or more of the ultrasound beacons.

29. The method of claim 28, wherein reevaluating the second position calculated using the inertial navigation system comprises calculating a sum of the first position weighted by a first factor and the second position weighted by a second factor.
